(19) United States
(12) Patent Application Publication
(10) Pub. No.: US 2010/0213288 A1
(43) Pub. Date: Aug. 26, 2010

(54) FLUID INJECTOR

(76) Inventor: Mauro Grandi, Livorno (IT)

Correspondence Address: King & Spalding LLP, 401 Congress Avenue, Suite 3200, Austin, TX, 78701, US

(21) Appl. No.: 12/707,852

(22) Filed: Feb. 18, 2010

(30) Foreign Application Priority Data
Feb. 20, 2009 (EP) 09002469

(51) Int. Cl. F02M 51/06; B21D 51/16

(52) U.S. Cl. 239/585.5; 29/890.124; 123/472

(57) ABSTRACT

A Fluid injector has a housing (8) with a cavity and a coil (34) being arranged in the cavity. A valve needle (12) is arranged axially moveable along a predetermined axis (L) of the fluid injector. An armature (14) is arranged axially moveable along the predetermined axis (L) and is mechanically coupled to the valve needle (12). A reluctance element (42) is designed to have a permeability which is much smaller than the permeability of the housing (8) and is arranged such that a magnetic circuit with the housing (8) and the armature (14) also has the reluctance element (42).

### CROSS-REFERENCE TO RELATED APPLICATIONS

This application claims priority to EP Patent Application No. 09002469 filed Feb. 20, 2009, the contents of which is incorporated herein by reference in its entirety.

### TECHNICAL FIELD

The present invention relates to a fluid injector.

### BACKGROUND

Fluid injectors are in widespread use, in particular as fuel injectors of internal combustion engines. Increasingly stringent rules concerning the admissibility of noxious emissions from internal combustion engines which are arranged in vehicles render it necessary to take various measures which reduce these emissions.

One way to reduce the emissions is to improve the combustion process in the internal combustion engine. This may be achieved by precisely dosing the fluid. This is a challenge in particular for small quantities of fluid to be dosed into a combustion chamber of an internal combustion engine.

### SUMMARY

According to various embodiments, a fluid injector can be provided which enables a reliable and fast dosing of a fluid.

According to an embodiment, a fluid injector may comprise a housing with a cavity and a coil arranged in the cavity, a valve needle being arranged axially moveable along a predetermined axis of the fluid injector, an armature being arranged axially moveable along the predetermined axis and being mechanically coupled to the valve needle, a reluctance element being designed to have a permeability which is much smaller than the permeability of the housing and being arranged such that a magnetic circuit comprising the housing and the armature also comprises the reluctance element.

According to a further embodiment, the reluctance element can be arranged and designed such that a magnetic flux of the magnetic circuit passes the reluctance element twice. According to a further embodiment, the reluctance element can be designed as a hollow cylinder and arranged such that in a direction perpendicular relative to the predetermined axis the reluctance element is arranged between the armature and the housing. According to a further embodiment, the reluctance element may have a relative permeability of below 100. According to a further embodiment, the reluctance element can be mechanically coupled to a valve body of the fluid injector. According to a further embodiment, the fluid injector may comprise a valve body being formed integrally with the reluctance element. According to a further embodiment, the valve body may have a permeability which is much smaller than the permeability of the housing. According to a further embodiment, the valve body may have a relative permeability of below 100.

### BRIEF DESCRIPTION OF THE DRAWINGS

Exemplary embodiments are shown in the following with the aid of schematic drawings. The figures are illustrating:

FIG. 1 a fluid injector,

FIG. 2 a section of the fluid injector showing a first embodiment,

FIG. 3 the section of the fluid injector showing a second embodiment.

Elements of the same design or function are referred to by the same reference numerals.

### DETAILED DESCRIPTION

According to various embodiments, a fluid injector may comprise a housing with a cavity and a coil being arranged in the cavity. A valve needle is arranged axially moveable along a predetermined axis of the fluid injector. An armature is arranged axially moveable along the predetermined axis and is mechanically coupled to the valve needle. A reluctance element is designed to have a permeability which is much smaller than the permeability of the housing, preferably by a factor of between 30 and 45, and is arranged such that a magnetic circuit comprising the housing and the armature also comprises the reluctance element. Surprisingly, upon a current feed of the coil, a magnetic field is established very quickly and after a de-activation of the current, the magnetic field dissipates very quickly. As a result, this allows a fast fluid injector having a short response time.

In an embodiment, the reluctance element is arranged and designed such that a magnetic flux of the magnetic circuit passes the reluctance element twice. This further shortens the response time of the fluid injector and such further decreases a delay between an actuation and a reaction of the fluid injector.

According to a further embodiment, the reluctance element is designed as a hollow cylinder and is arranged such that in a direction perpendicular relative to the predetermined axis the reluctance element is arranged between the armature and the housing. This enables a simple and cheap fluid injector.

In a further embodiment, the relative permeability of the reluctance element is below 100. This enables a fast response time of the fluid injector.

In a further embodiment, the reluctance element is mechanically coupled to a valve body of the fluid injector. This enables a simple fluid injector which can be easily manufactured.

In a further embodiment, the fluid injector comprises a valve body being formed integrally with the reluctance element. This enables a cheap production and a simple assembly of the fluid injector. A number of welding seams which is necessary for the manufacturing can effectively be reduced. This can increase the mechanical stability and thus the life-time of the fluid injector.

In a further embodiment, the valve body has a permeability which is much smaller than the permeability of the housing, preferably by a factor of between 30 and 45. This enables an advantageous guidance of the magnetic flux in the housing and the armature by a reduction of the magnetic flux in the valve body.

In a further embodiment, the relative permeability of the valve body is below 100. This enables an advantageous guidance of the magnetic flux in the fluid injector with the magnetic flux in the valve body being kept small. As a result, the magnetic flux being guided by the magnetic circuit and in particular by the armature can be increased such that the force exerted by the magnetic field on the armature can also be increased. This enables a reliable fluid injector.

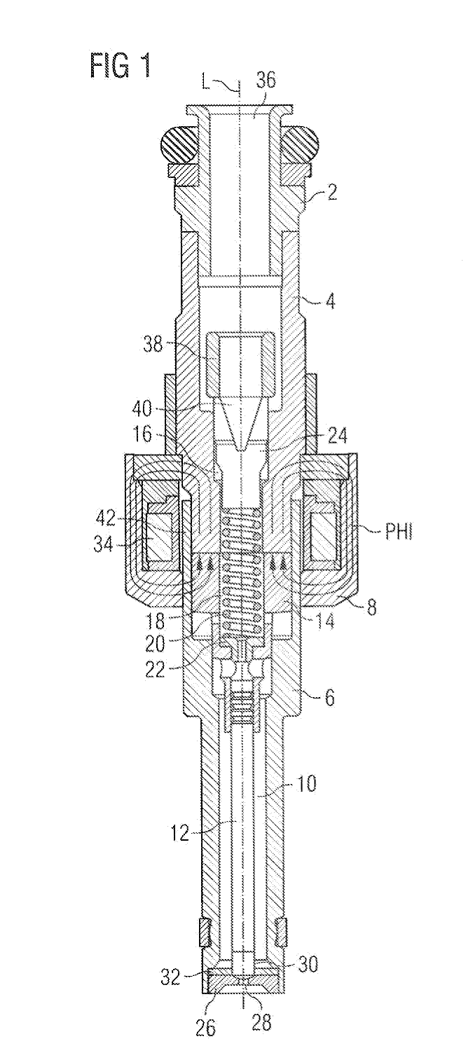

A fluid injector (FIG. 1) which is in particular suited for dosing fuel into an internal combustion engine comprises a fitting adapter 2 being designed to mechanically and hydraulically couple the fluid injector to a fluid reservoir, such as a fuel rail. The fluid injector has a predetermined axis L and further comprises an inlet tube 4, a valve body 6 and a housing 8. A body of the fluid injector may therefore comprise one or more of the fitting adapter 2, the inlet tube 4, the valve body 6 and the housing 8.

A recess 10 in the valve body 6 is provided which takes in a valve needle 12 and preferably a part of an armature 14. The valve needle 12 is mechanically coupled to the armature 14. A recess of the inlet tube 16 is provided which hydraulically communicates with a recess of the armature 18. A spring 20 is arranged in the recess of the inlet tube 16 and/or the recess of the armature 18. Preferably, the spring 20 rests on a spring seat being formed by an anti-bounce disk 22. The spring 20 is in this way mechanically coupled to the valve needle 12. An adjusting tube 24 is provided in the recess of the inlet tube 16. The adjusting tube 24 forms the further seat for the spring 20 and may during the manufacturing process of the fluid injector be axially moved in order to preload the spring 20 in a desired way.

In a closing position of the fluid injector, the valve needle 12 sealingly rests on a seat 26 and prevents in this way a fluid flow through at least one injection nozzle 28. The injection nozzle 28 may, for example, be an injection hole, it may, however, also be of some other type suitable for dosing fluid. The seat 26 may be made as one part with the valve body 6 or may also be made as a separate part. In addition to that, preferably a lower guide 30 for guiding the valve needle 12 is provided. In addition, preferably a swirl disk 32 may be provided.

The fluid injector is provided with a drive, comprising a coil 34, which is preferably overmolded. During the manufacturing process of the fluid injector the adjusting tube 24 is pushed into the recess of the inlet tube 16 to an initial position. Afterwards, the fluid injector may be calibrated. The coil 34 can successively be energised which results in an electromagnetic force acting on the armature 14 and such on the valve needle 12 which is mechanically coupled to the armature 14 and acting against the mechanical force obtained from the spring 20. After a given time the coil 34 can be de-energised again. By appropriately energising the coil 34, the valve needle 12 may in that way be moved away from its closing position resulting in the fluid to flow through the injection nozzle 28. The fluid flow or the amount of dosed fluid may then be measured and a desired correlation between a control signal for energising and de-energising the coil 34 and an actual amount of dosed fluid may be calibrated by axially moving the adjusting tube 24. In this way, the preloading force of the spring 20 may be adjusted.

When the desired control characteristic of the fluid injector is obtained, the inlet tube 4 may be plastically deformed in a way that the adjusting tube 24 is axially fixed in respect to the inlet tube 4. Preferably after this, an overmolded portion of the housing 8 is then created by a molding process and in that way also a connector for electrically connecting the fluid injector externally may be created.

A fluid inlet 36 is provided in the fitting adapter 2 which communicates with a filter 38. The adjusting tube 24 is designed for the fluid to flow through it towards the injection nozzle 28. For this purpose, the anti-bounce disk 22 is provided with an appropriate recess which communicates hydraulically with the recess of the armature 14.

The adjusting tube 24 is provided with a damper 40. The damper 40 is designed for dampening the fluid flow. The damper 40 comprises at least one orifice, through which the fluid must flow when flowing from the fluid inlet 36 of the injector to the at least one injection nozzle 28.

The housing 8 and the armature 14 form an electromagnetic circuit together with a reluctance element 42. The magnetic circuit guides a magnetic flux PHI of a magnetic field being generated by the coil 34. The reluctance element 42 is arranged between the armature 14 and the housing 8 and is designed such that its permeability is much smaller than the permeability of the housing 8. Preferably, the permeability of the reluctance element 42 is about 30 to 45 times smaller than the permeability of the housing 8.

The design and the arrangement of the reluctance element 42 shows a surprising effect which turns out to be a huge advantage: Due to the reluctance element 42 with its small permeability the magnetic field which is generated by the coil 34 upon a supply of a current to the coil 34 is established much faster than without the reluctance element 42. If the current is switched off, the magnetic field also dissipates much faster. Thus, the reluctance element 42 with its small permeability results in a very fast response time of the fluid injector. An important inconvenience of known solenoid fluid injectors, their long response times, can be overcome or at least decreased by the reluctance element 42.

In an embodiment, the reluctance element 42 is designed as a hollow cylinder and arranged such that in a direction perpendicular relative to the predetermined axis L, the reluctance element 42 is arranged between the armature 14 and the housing 8. The width of the reluctance element 42 can be for example between 0.4 and 0.9 mm. The width of the reluctance element 42 may also be of another value. In an embodiment, the reluctance element 42 is made of austenite. It is known that austenite is not ferromagnetic and thus shows only poor magnetic characteristics. In a further embodiment, the reluctance element 42 and the valve body 6 are made as one part.

In a further embodiment, the valve body 6 has a permeability which is much smaller than the permeability of the housing. The relative permeability of the valve body 6 can be for example below 100. The valve body 6 can be made, for example, of austenite. The small permeability of the valve body 6 results in an advantageous guidance of the magnetic flux PHI in the fluid injector. The magnetic flux PHI in the valve body can be kept small. As a result, the magnetic flux PHI being guided by the magnetic circuit and in particular by the armature 14 is stronger such that the force being exerted on the armature by the magnetic field is stronger.

The integral construction of the reluctance element 42 and the valve body 6 being made as one part has got the advantage that the number of welding seams can be decreased.

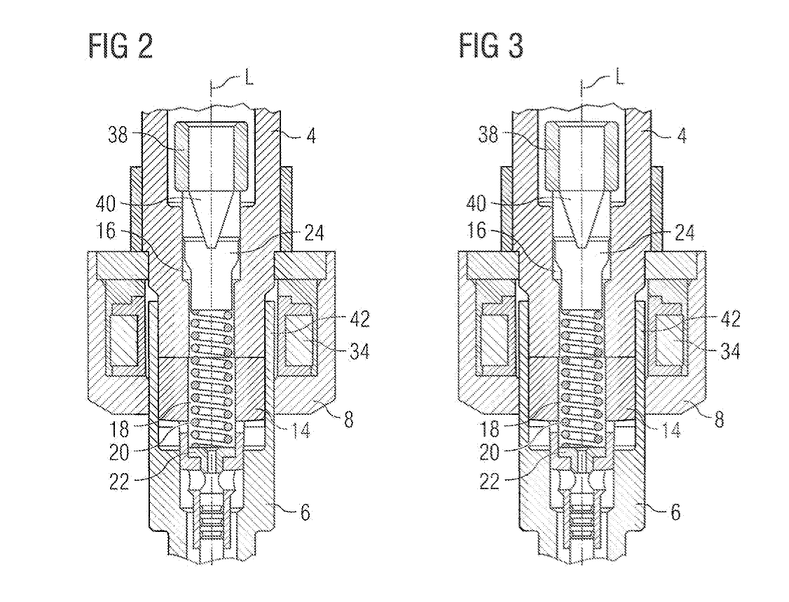

FIG. 2 shows a first embodiment of the reluctance element 42. In FIG. 2 the reluctance element 42 is designed such that the magnetic flux PHI of the magnetic circuit passes the reluctance element 42 once.

FIG. 3 shows a second embodiment of the fluid injector. In the second embodiment of the fluid injector, the reluctance element 42 is designed such that the magnetic flux PHI of the magnetic circuit passes the reluctance element 42 twice. This further shortens the response time of the fluid injector.

What is claimed is:

1. A fluid injector, comprising
a housing with a cavity and a coil arranged in the cavity,
a valve needle being arranged axially moveable along a predetermined axis of the fluid injector,
an armature being arranged axially moveable along the predetermined axis and being mechanically coupled to the valve needle,
a reluctance element being designed to have a permeability which is much smaller than a permeability of the housing and being arranged such that a magnetic circuit comprising the housing and the armature also comprises the reluctance element.

2. The fluid injector according to claim 1, wherein the permeability of the reluctance element is smaller than the permeability of the housing by a factor of between 30 and 45.

3. The fluid injector according to claim 1, wherein the reluctance element is arranged and designed such that a magnetic flux of the magnetic circuit passes the reluctance element twice.

4. The fluid injector according to claim 1, wherein the reluctance element is designed as a hollow cylinder and arranged such that in a direction perpendicular relative to the predetermined axis the reluctance element is arranged between the armature and the housing.

5. The fluid injector according to claim 1, wherein the reluctance element having a relative permeability of below 100.

6. The fluid injector according to claim 1, wherein the reluctance element is mechanically coupled to a valve body of the fluid injector.

7. The fluid injector according to claim 1, wherein the fluid injector comprises a valve body being formed integrally with the reluctance element.

8. The fluid injector according to claim 6, wherein the valve body has a permeability which is much smaller than the permeability of the housing.

9. The fluid injector according to claim 8, wherein the permeability of the valve body is smaller than the permeability of the housing by a factor of between 30 and

10. The fluid injector according to claim 6, wherein the valve body has a relative permeability of below 100.

11. A method for providing a fluid injector, comprising the steps of:
arranging a coil in a cavity of a housing,
arranging a valve needle axially moveable along a predetermined axis of the fluid injector,
arranging an armature axially moveable along the predetermined axis and mechanically coupling the armature to the valve needle,
arranging a reluctance element with a permeability which is much smaller than a permeability of the housing such that a magnetic circuit comprising the housing and the armature also comprises the reluctance element.

12. The method according to claim 11, wherein the permeability of the reluctance element is smaller than the permeability of the housing by a factor of between 30 and 45.

13. The method according to claim 11, comprising the step of arranging and designing the reluctance element such that a magnetic flux of the magnetic circuit passes the reluctance element twice.

14. The method according to claim 11, comprising the steps of designing the reluctance element as a hollow cylinder and arranging the reluctance element such that in a direction perpendicular relative to the predetermined axis the reluctance element is arranged between the armature and the housing.

15. The method according to claim 11, wherein the reluctance element having a relative permeability of below 100.

16. The method according to claim 11, comprising the step of mechanically coupling the reluctance element to a valve body of the fluid injector.

17. The method according to claim 11, wherein the fluid injector comprises a valve body being formed integrally with the reluctance element.

18. The method according to claim 16, wherein the valve body has a permeability which is much smaller than the permeability of the housing.

19. The method according to claim 16, wherein the valve body has a relative permeability of below 100.

20. The method according to claim 18, wherein the permeability of the reluctance element is smaller than the permeability of the housing by a factor of between 30 and 45.
